(19) United States
(12) Patent Application Publication
(10) Pub. No.: US 2026/0254173 A1
(43) Pub. Date: Aug. 27, 2026

(54) COMPUTERIZED WIRE CONNECTOR AND METHOD OF OPERATING COMPUTERIZED WIRE CONNECTOR

(71) Applicant: HARTING INTERNATIONAL INNOVATION AG, Biel (CH)

(72) Inventors: Andrew CHANG, Castro Valley, CA (US); Jackson SNOWDEN, Boston, MA (US)

(73) Assignee: HARTING INTERNATIONAL INNOVATION AG, Biel (CH)

(21) Appl. No.: 19/160,122

(22) PCT Filed: Feb. 9, 2024
(86) PCT No.: PCT/EP2024/053312

§ 371 Date: Aug. 27, 2025

Related U.S. Application Data
(60) Provisional application No. 63/448,397, filed on Feb. 27, 2023.

(51) Int. Cl. H01R 13/66; H01R 13/506; H01R 13/6581; H01R 13/6598; H01R 24/60

(52) U.S. Cl. CPC H01R 13/665; H01R 13/506; H01R 13/6581; H01R 24/60; H01R 13/6598; H01R 13/6683

(57) ABSTRACT

A computerized wire connector, comprising a plug unit having a plurality of interfacing pins for electrically interfacing with a mating device, a microcomputer having a microprocessor, memory, and at least one printed circuit board (PCB) carrying both the microprocessor and the memory and having connection points for connecting to wires carried by a cable to which the computerized wire connector is to be attached, and a cover housing the plug unit and the microcomputer.

### TECHNICAL FIELD

The present disclosure relates generally to cable or wire connectors for providing a connection interface for wires within a cable and, more particularly, relates to computerized cable or wire connectors.

### BACKGROUND ART

In the field of cable or wire connectors, there is the need to digitally identify and communicate with the physical connector in an industrial setting. This need arises when the device attached to the connector, such as an analog sensor or a power supply, is not capable of digital communication or data storage. Designing the connector to accomplish those tasks itself enables digital functionality with any device that may be wired to the connector. This problem is addressed in prior art. However, known products are bulky and/or are limited to specific communication networks.

### DISCLOSURE OF THE INVENTION

According to a first aspect of the invention, a computerized wire connector is provided. The computerized wire connector comprises: a plug unit having a plurality of interfacing pins for electrically interfacing with a mating device; a microcomputer having a microprocessor, memory, and at least one printed circuit board (PCB) carrying both the microprocessor and the memory and having connection points for connecting to wires carried by a cable to which the computerized wire connector is to be attached; and a cover housing the plug unit and the microcomputer.

According to a second aspect of the invention, a computerized wire connector is provided. The computerized wire connector comprises: a cover; a shield unit surrounded by the cover; a plug unit surrounded by the shield unit and having a body portion and a plug portion that has a plurality of interfacing pins for electrically interfacing with a mating device, wherein the body portion includes an intra-shielded space; and a microcomputer having a microprocessor, memory, and at least one printed circuit board (PCB) carrying both the microprocessor and the memory and having connection points for connecting to wires carried by a cable to which the computerized wire connector is to be attached, wherein the microcomputer is disposed within the intra-shielded space of the body portion of the plug unit.

Other aspects and features are defined in the appended claims.

Examples of the disclosure may make it possible to obtain a connector device that is significantly more compact than existing devices while maintaining nearly all the same features. In addition, the connector according to the present invention allows the possibility to easily track and monitor in-field repairs and maintenance problems with higher degree of accuracy.

### BRIEF DESCRIPTION OF THE DRAWINGS

Examples of the disclosure will now be described by way of example only with reference to the accompanying drawings, in which like references refer to like parts, and in which:

FIG. 1 shows an exploded view of a computerized wire connector according to an example;

FIG. 2 shows an assembled view of a computerized wire connector according to an example;

FIG. 3 shows a plug unit according to an example;

FIG. 4 shows a front view of the computerized wire connector of FIG. 2;

FIG. 5 shows a top view of the computerized wire connector of FIG. 2;

FIG. 6 shows a microprocessor used in the computerized wire connector of FIG. 2;

FIG. 7 shows a communication system according to an example; and

FIG. 8 shows a method for operating a computerized wire connector as a part of a communication network according to an example.

### DETAILED DESCRIPTION OF ILLUSTRATIVE EMBODIMENTS

Referring generally to the drawings, there is shown a computerized wire connector connectable to an end of a cable and having interfacing connector pins for transmitting signals from a mating device to wires carried in the cable, with the connector being computerized in that it includes a microcomputer having a plurality of connection points for connecting to wires carried in the cable. The microcomputer has at least one printed circuit board (PCB), a microprocessor, and non-transitory, computer-readable memory (simply, “memory”) and, in embodiments, the at least one PCB, microprocessor, and memory collectively constitute the microcomputer. At least in some embodiments, the connector is an industrial cable connector used for serial communications, such as for transmitting data from a sensor or other peripheral mating device to a programmable logic controller (PLC) or other central downstream computer. The microcomputer is housed within the connector housing of the connector and is used to communicate with a downstream device (e.g., central computer) and store data, such as metadata, in the memory. The downstream device may be a central computer or host computer that is used to communicate with the computerized wire connector 10 and, in embodiments, with a plurality of computerized wire connectors.

In an industrial setting, industrial connectors, such as industrial ethernet-interfaced connectors such as the HARTING iX Industrial® connector, are used for carrying signals between two devices, such as between a peripheral device (or mating device) and a central computer (downstream device). In one embodiment, the computerized wire connector is an ANSI or International Electrical Commission (IEC) 61076-3-124 connector that further has the microcomputer embedded in an intra-shielded space (ISS), such as in a shelf area of a plug unit of the connector. Other IEC certifications can be taken into account to ensure robustness, such as IEC 6100-4-3 and IEC 6100-4-6 as expected qualifications for electro-magnetic interference rejection. In embodiments, the microcomputer is used for accessing a connector identifier (ID) that is stored with in the memory of the microcomputer and that is used to uniquely identify the connector from other connectors. At least in some embodiments not specifically illustrated, the microcomputer can feature a temperature sensor and/or humidity sensor disposed on and supported by the PCB. The temperature sensor and/or humidity sensor can be operatively coupled to the microprocessor for sensing and recording the environment of the connector over time. The microprocessor can be configured and programmed to read the sensor signal provided by the temperature and/or humidity sensor and store said signal(s) in memory.

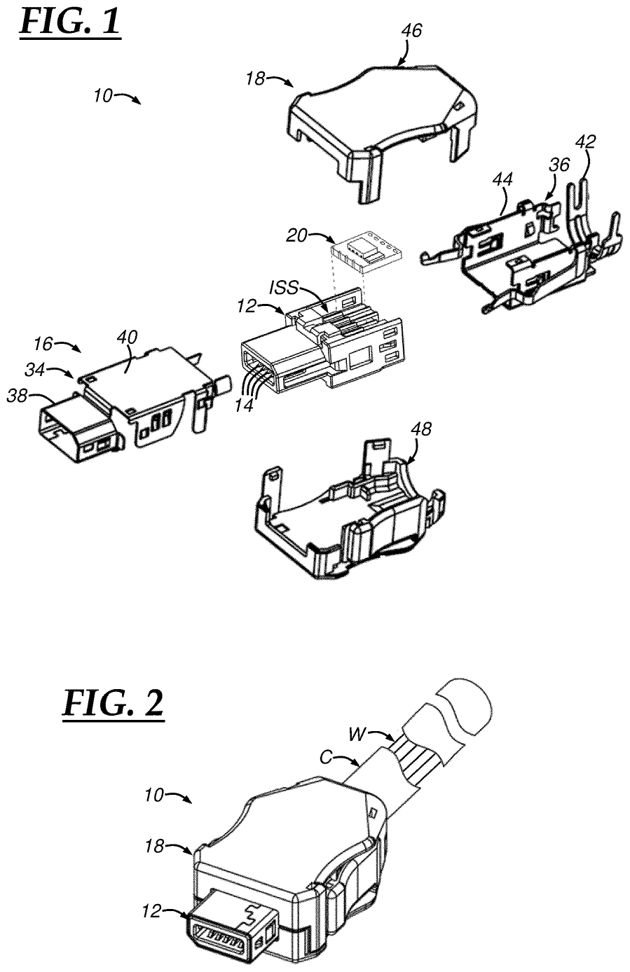

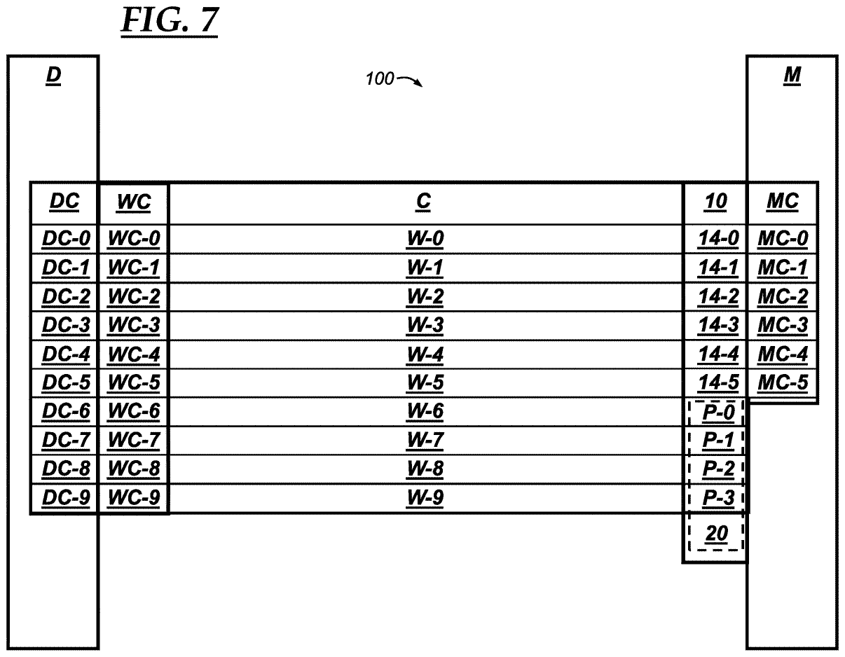

With reference to FIGS. 1 and 2, according to a first embodiment, there is shown a computerized wire connector 10 for connecting a plurality of wires W to a plug unit 12 having a plurality of interfacing contacts 14 for connecting the computerized wire connector 10 to a mating device M (FIG. 7). The computerized wire connector 10 includes the plug unit 12 with the plurality of interfacing contacts 14, a shield unit 16 comprised of an electromagnetic shielding material (e.g., metal) shaped to surround the plug unit 12, a cover 18 surrounding the shield unit 16, and a microcomputer 20. The plurality of interfacing contacts 14 are used to physically engage with corresponding electrical contacts of a mating connector MC (FIG. 7), which may be a female mating connector. Even though the computerized wire connector 10 is a male connector in the illustrated embodiment, in other embodiments, the computerized wire connector 10 is a female connector and the mating connector is a male connector. In embodiments, the computerized wire connector 10 is a compact computerized wire connector, which is discussed more below. The computerized wire connector 10 extends longitudinally in a longitudinal or extension direction of a cable C to which it is to be connected to, as shown by the longitudinal axis A in FIG. 5. In the illustrated embodiment, the computerized wire connector 10 is configured as a 10-way, shielded, free and fixed rectangular connector for data transmission with frequencies up to 500 MHz, and is configured according to IEC 61076-3-124 with 10 electrical pins. In embodiments, three or four of the ten electrical pins are not used by the mating device M for transmission of signals from the mating device M to the downstream device D; rather, the three or four electrical pins are used for connecting the downstream device D to the microcomputer 20 of the computerized wire connector 10, as shown in FIG. 7, which is discussed more below.

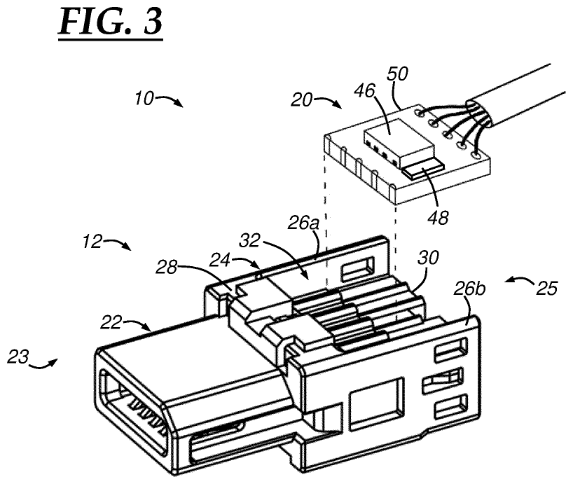

With reference to FIG. 3, the plug unit 12 includes a plug portion 22 located at a mating end 23 and a body portion 24 located at a wire connection end 25. In general, the electrical contacts 14 are conductively connected to the wires W of the cable C (FIG. 7). The body portion 24 includes two side walls 26a, b that extend parallel to one another (and relative to longitudinal axis A) and each meet a center wall 28 with a base wall 30 extending therebetween. This space is referred to as a shelf area 32 and is configured to receive terminal portions of the wires W at the wire connection end 25 that are then physically crimped onto corresponding ones of the electrical contacts 14. Generally, the plug unit 12 is comprised of an insulative material, such as polyamide (nylon) or low density polyethylene (LDPE). The electrical contacts 14 are made of a suitable material, such as copper. Of course, these materials are only exemplary as various other materials may be used. In embodiments, the wires W are 22 to 30 AWG and, more particularly, 24 to 28 AWG.

The shield unit 16 provides an electromagnetic shield around the plug unit 12 so as to guard against electromagnetic interference, and may be comprised of a suitable material, such as nickel-plated zinc, for example. The shield unit 16 includes two halves including a top (or first) half 34 and a bottom (or second) half 36, sometimes referred to as a shield shell 34 and a shield case 36. The shield shell 34 includes a plug portion 38 and a body portion (or top body portion) 40, where the plug portion 38 is shaped to surround the plug portion 22 of the plug unit 12 and the body portion 40 is shaped to surround the body portion 24 of the plug unit 12. The shield case or bottom half 36 of the shield unit 16 includes a cable portion 42 and a body portion (or bottom body portion) 44, where the cable portion 42 includes bent, cantilevered prongs extending circumferentially (relative to axis A) and oppositely from one another relative to a common connection point so that the two prongs may be deformed or crimped inwardly toward a cable therethrough. The body portion 44 of the body half 36 is shaped to surround the body portion 24 of the plug unit 12. The top half 34 and the bottom half 36 mate with one another so as to be held fixed together and surrounding the plug unit 12.

The shelf area 32, which is provided between the two side walls 26a,b, the center wall 28, the base wall 30, and the body portion 40 of the shield shell 34, is an example of an intra-shield space (ISS) that may be occupied by the microcomputer 20. As used herein, the term “intra-shielded” refers to surrounded (at least radially surrounded relative to the longitudinal axis A (FIG. 5)) by a shield portion, such as the shield shell 34 or shield case 36; in the illustrated embodiment, the intra-shielded space ISS is surrounded on the top side by the shield shell 34, on the bottom side by the shield case 36, and by both the shield shell 34 and the shield case 36 on the right and left sides.

The cover 18 includes an upper cover case 46 and a lower cover case 48, each of which may be comprised of a plastic material, for example. The upper cover case 46 and the lower cover case 48 have engaging, complementary connection portions that are used to hold the upper cover case 46 fixedly to the lower cover case 48 after being resiliently pressed together over the shielded plug unit 12 and microcomputer 20.

The microcomputer 20 includes a microprocessor 46, memory 48, and at least one printed circuit board (PCB) 50 that is shown as a single; however, in embodiments, more than one PCB may be used. The microprocessor 46 may be any suitable microprocessor or microcontroller, such as an Arm-based microcontroller or a 16-pin MSP430 microcontroller by Texas Instruments™. Of course, other microcontrollers or integrated circuits, such as application specific integrated circuits (ASICs) may be used as the microprocessor 46. The memory 48 is a non-transitory, computer-readable memory 48, which may be implemented as any suitable non-volatile electronic memory, such as electrically erasable programmable read-only memory (EEPROM). In one embodiment, the memory 48 is a MICROCHIP 24LC 256 serial EEPROM used for 2.5 to 5.5V operation. The microprocessor 46 and memory 48 are disposed on the at least one PCB 50 and, which is depicted as a single PCB in the illustrated embodiment. The microcomputer 20 may be sized so as to fit in the shelf area 32, such as on the base wall 30 that defines a bottom extent of the shelf area 32.

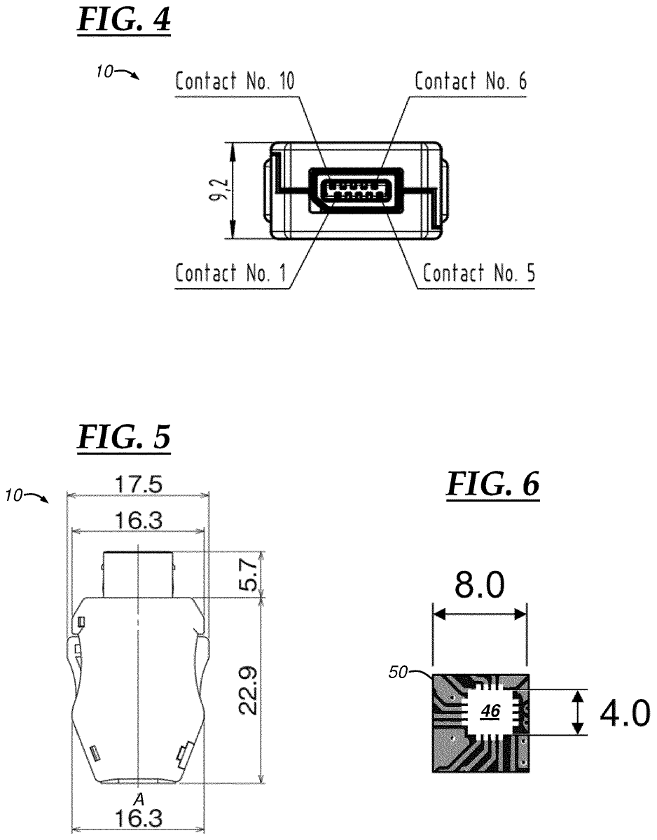

With reference to FIGS. 4-6, there are shown exemplary dimensions for various parts of the computerized wire connector 10, according to an embodiment in which the computerized wire connector 10 is a compact computerized wire connector.

The computerized wire connector 10 shown in the exemplary embodiment of FIGS. 4-6 has a width of 17.5 millimeters (mm), a body length of 22.9 mm, a plug length of 5.7 mm, and a thickness of 9.2 mm. As used herein, “compact” means that a total volume encapsulated by the cover is less than 5 cm³ (cubic centimeters). As used herein, “slim” means that a total thickness of the cover is less than or equal to 10 mm.

According to one embodiment, the microcomputer 20 is incorporated into a space within a HARTING iX Industrial® connector or International Electrical Commission (IEC) 61076-3-124 connector. In such embodiments, the PCB 50 and the microprocessor 46 of the microcomputer 20 are comprised of sufficiently small components-in particular, the PCB 50 is shown as being 8.0 mm wide and the microprocessor 46 is shown as being 4.0 mm in length; in embodiments, the PCB 50 is 8.0 mm in length as well and/or the microprocessor 46 is 4.0 mm in width as well. According to embodiments, the PCB 50 is less than 1.5 cm². Of course, according to other embodiments, the sizes and dimensions of the components of the computerized wire connector may vary.

In other embodiments, the computerized wire connector 10 further includes a light for emitting visible light for purposes of providing a visual indicator to a user of the connector 10 or the cable C. The light may be a light emitting diode (LED), for example, and may be controlled by the microprocessor 46. In such embodiments, the cover 18 may include an opening or transparent window so that light emitted by the light is observable by the user of the computerized wire connector 10.

With reference to FIG. 7, there is shown a communication system 100 having a downstream device D connected to a mating device M via the computerized wire connector 10 that is attached to one end of the cable C that carries a plurality of wires W (individually, W-n, where n is an index from 0 to N-1 where N is the total number of wires in the cable C). Each wire W-n of the plurality of wires W is connected to a corresponding electrical contact or interfacing contact of a wire connector WC that is mated to the downstream device D via physical connection to a downstream device connector DC having N interfacing contacts DC-n. At the other end of the cable C, the computerized wire connector 10 is connected to each of the wires W, with six of the wires W-0 through W-5 being directly connected to a corresponding electrical contact 14-1 through 14-5 and four of the wires W-6 through W-9 being connected to the PCB 50 at a respective PCB connection point P-0 through P-3. In some cases, different communication protocols may require a different wire configuration, e.g., the use of more than four conductors. For example, it may be that using “SPI” protocol would take six of the ten existing wires. According to one embodiment, the downstream device D is connected to the computerized wire connector 10 via the four wires W-6 through W-9, which are connected to connection points P-0 through P-3 with P-0 being used for a data signal (e.g., serial data (SDA)), P-1 being used for a clock signal (e.g., serial clock line (SCL)), P-2 being used for providing voltage (V+), and P-3 being used for ground (GND); such a configuration may be used when using an Inter-Integrated Circuit (I2C) bus. According to other embodiments, Serial Peripheral Interface (SPI), universal asynchronous receiver/transmitter (UART), or Universal Serial Bus (USB) may be used for data communications between the controller and another device, such as the downstream device D. In embodiments, direct current is provided via the V+wire, such as at 5 Volts (5VDC). In some embodiments, only three wires W are connected to the microcomputer 20.

The downstream device D is a computer, such as a PLC or a central computer, and the mating device M is a peripheral device, such as a power supply, contact sensor, or other device capable of serial wire communications, such as those devices of an industrial communications network, many of which conventionally used D-subminiatures (D-subs) or non-computerized HARTING™ iX connectors. The computerized wire connector 10 is illustrated as an industrial wire connector for use in carrying data transmissions from the mating device M to the downstream device D. In some embodiments, the mating device D is an analog device and is not capable of digital communication and/or storage. The computerized wire connector 10 enables computerization of such peripheral or mating devices through introduction of the microcomputer 20 and its associated wiring that electrically connects its connection points on the PCB 50 to wires W-6 to W-9 of the cable C. Operation of the computerized wire connector 10 within the communication network 100 is discussed below.

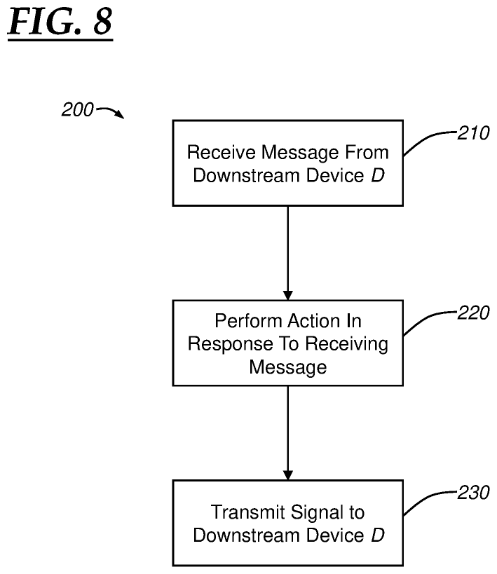

With reference to FIG. 8, there is shown a method 200 for operating a computerized wire connector as a part of a communication network. The method 200 begins with step 210, wherein a message is received from the downstream device D. For example, with reference to the embodiment of FIG. 7, the message is transmitted from the downstream device D to the computerized wire connector 10 via use of the wire W-6 and connection point P-0. The message may be transmitted using a serial data communication protocol and received at the microcomputer 20. The method 200 continues to step 220.

In step 220, the microcomputer performs an action in response to the received message. In one embodiment, the action is determined based on the message, which may include a command that instructs the microcomputer 20 to retrieve values or data from memory (“memory retrieval feature”), compute new values (“computation feature”), and/or storing new data in memory (“memory storing feature”). For example, the computation feature includes encryption of data using digital keys stored securely in the microcomputer 20, such as in the memory 48; and, in an example, the memory storing feature includes storing new data, such as identification data or updated device identification data, into the memory 48. In embodiments, the action is restricting memory access based on use of passwords or restricting external memory access entirely, such that the downstream device D or mating device M may not access contents of the memory 48. In yet another embodiment, the action is sending data to a downstream device D, such as a connector ID and/or a mating device ID. The mating device ID is an identifier used to identify the mating device M that is connected to the computerized wire connector 10. In embodiments, the mating device ID is provided from the downstream device D to the computerized wire connector 10 for storage as a part of an initial mating device pairing process where the connector 10 and the mating device M are paired (or associated) with one another. For example, in embodiments, the pairing process is performed in response to detecting the computerized wire connector 10 being connected to the mating device M, which may be performed by the downstream device D based detecting an electrical connection between the interfacing contacts DC-n of the downstream device D and the interfacing contacts MC-n of the mating device M. The downstream device D may then send a mating device ID to the computerized wire connector 10. This pairing process may be carried out during a setup or initial configuration of equipment in an industrial setting and mating device IDs may be generated and assigned to mating devices. In some scenarios, certain peripheral or mating devices are analog in nature and are not configured for digital communications or storage; as such, these devices have no known digital identity and one may be generated by the downstream device D or other computer for initial provisioning or setup of the communications system 100, which may involve performing the pairing process for the computerized wire connector 10 and the mating device M; in embodiments, a plurality of computerized wire connectors (each equivalent to the computerized wire connector 10) may be used and paired with a corresponding mating device M. Then, after pairing and during operation, the downstream device D may thus identify the particular mating device for signals being transmitted through receipt of a mating device ID from the microcomputer 20 via the cable C.

In even yet another embodiment, the action is performing error correction on bits communicated over the wires W. In such embodiments, the error correction may be performed on metadata transmitted by the computerized wire connector 10 and, when it is determined that there is or may be an error, the microcomputer 20 may request a new command or message from the downstream device D. It should be appreciated that a combination of actions may be performed in this step as well. The method 200 continues to step 230.

In step 230, a signal is transmitted from the computerized wire connector 10 to the downstream device D via the cable C; more particularly, the signal is transmitted using the W-6 wire connected to the connection point P-O, and the signal includes data obtained from the memory 48 and/or computed based on data received in the message (step 310) or data stored in the memory 48. The data obtained from the memory 48 may be an identifier (ID), such as a unique ID that uniquely identifies the computerized wire connector 10 from other connectors or that uniquely identifies a mating device to which the computerized wire connector 10 is connected to. In some embodiments, the ID is prestored as prestored data that is stored in the microcomputer 20, such as in the memory 48, at a time of manufacturing. The method 200 ends.

While the method 200 is described and illustrated as having three steps being performed in a particular order, it should be appreciated that, according to embodiments, the method 200 may omit one or more of these steps. For example, in one embodiment, a method includes steps 210 and 220, but not (necessarily) step 230. In another embodiment, a method includes step 230 but not (necessarily) steps 210 and 200.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

All terms used in the claims are intended to be given their broadest reasonable construction and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

1. A computerized wire connector, comprising:
a plug unit having a plurality of interfacing pins for electrically interfacing with a mating device;
a microcomputer having a microprocessor, memory, and at least one printed circuit board (PCB) carrying both the microprocessor and the memory and having connection points for connecting to wires carried by a cable to which the computerized wire connector is to be attached; and
a cover housing the plug unit and the microcomputer.

2. The computerized wire connector of claim 1, wherein the computerized wire connector is compact such that a total volume encapsulated by the cover is less than 5 cm³.

3-4. (canceled)

5. The computerized wire connector of claim 1, wherein the cover is a slim cover such that a thickness of the cover is less than or equal to 10 mm.

6. The computerized wire connector of claim 1, wherein the memory is an electronically-erasable read-only memory (EEPROM).

7. The computerized wire connector of claim 6, wherein the computerized wire connector is a computerized International Electrical Commission (IEC) 61076-3-124 connector.

8. The computerized wire connector of claim 1, wherein the microcomputer is configured to obtain data from the memory and transmit the data to a downstream device via the wires carried by the cable.

9. The computerized wire connector of claim 8, wherein the wires connected to the PCB are not in electrical communication with other wires of the cable that are in electrical communication with the plurality of interfacing pins.

10. The computerized wire connector of claim 9, wherein the other wires of the cable are exclusively used for transmission of data from the mating device to the downstream device.

11. The computerized wire connector of claim 10, wherein the microcomputer is configured to send one or more identifiers (IDs) to the downstream device via the wires where the IDs identify the mating device and/or the computerized wire connector.

12. The computerized wire connector of claim 11, wherein the microcomputer is configured to store a mating device ID as a result of being paired to the mating device.

13. The computerized wire connector of claim 12, wherein the computerized wire connector is paired to the mating device as a result of a pairing process that is performed in response to detecting the computerized wire connector being connected to the mating device.

14. The computerized wire connector of claim 13, wherein the pairing process includes storing the mating device ID into the memory in response to receiving the mating device ID from the downstream device.

15. (canceled)

16. The computerized wire connector of claim 1, wherein the connection points of the PCB include a voltage (V+) line, a ground (GND) line, a serial data line (SDA), and a serial clock line (SCL).

17. The computerized wire connector of claim 1, wherein the downstream device is configured to provide voltage via the voltage (V+) line in order to power the microcomputer.

18. The computerized wire connector of claim 1, further comprising a light configured to emit visible light, wherein the light is electrically connected to the PCB and controllable by the microcomputer.

19. The computerized wire connector of claim 18, wherein the microcomputer is configured to provide an indication via the light in response to a message received from a downstream device that is in communication with the microcomputer via the wires carried by the cable.

20. The computerized wire connector of claim 1, the microcomputer having a temperature sensor and/or humidity sensor arranged on and carried by the PCB, wherein the temperature sensor and/or humidity sensor being operably coupled to the microprocessor for sensing and recording the ambient environment.

21. A computerized wire connector, comprising:
a cover;
a shield unit surrounded by the cover;
a plug unit surrounded by the shield unit and having a body portion and a plug portion that has a plurality of interfacing pins for electrically interfacing with a mating device, wherein the body portion includes an intra-shielded space; and
a microcomputer having a microprocessor, memory, and at least one printed circuit board (PCB) carrying both the microprocessor and the memory and having connection points for connecting to wires carried by a cable to which the computerized wire connector is to be attached,
wherein the microcomputer is disposed within the intra-shielded space of the body portion of the plug unit.

22. The computerized wire connector of claim 20, wherein the body portion includes a shelf area, and wherein the microcomputer is disposed within the shelf area of the body portion.

23. The computerized wire connector of claim 21, wherein the shelf area is defined as an area between two side walls, a central wall, and a base wall of the body portion of the plug unit.

24. The computerized wire connector of claim 20, wherein the computerized wire connector is an International Electrical Commission (IEC) 61076-3-124 connector with the microcomputer being disposed in a shelf area of the body portion of the plug unit.
